(19) United States
(12) Patent Application Publication
(10) Pub. No.: US 2018/0056453 A1
(43) Pub. Date: Mar. 1, 2018

(54) HIGH SURFACE ROUGHNESS ALLOY FOR CLADDING APPLICATIONS

(71) Applicant: Polymet Corporation, Cincinnati, OH (US)

(72) Inventors: Tim A. Barnhart, Bowling Green, KY (US); Nicholas J. Latona, Dublin, OH (US)

(21) Appl. No.: 15/251,800

(22) Filed: Aug. 30, 2016

(51) Int. Cl. B23K 35/30; C22C 38/38; C22C 38/36; C22C 38/34; C22C 38/32; C22C 38/26; C22C 38/24; C22C 38/22

(52) U.S. Cl. CPC B23K 35/306; C22C 38/38; C22C 38/36; C22C 38/22; C22C 38/32; C22C 38/26; C22C 38/24; C22C 38/34

(57) ABSTRACT

Cladding deposit compositions with improved surface roughness are provided by balancing percent weights of finely dispersed carbides such as Boron (B), Chromium (Cr), Molybdenum (Mo), Niobium (Nb), Vanadium (V), and Tungsten (W). The result is a deposit with high surface roughness, high hardness, and high stress abrasion resistance while increasing bond strength from ˜7,000 psi to ˜60,000 psi when compared to typical anti-skid cladding alloys.

### BACKGROUND

The statements in this section merely provide background information related to the present disclosure and may not constitute prior art.

The present disclosure relates to high surface roughness alloy compositions for cladding applications, and more particularly to thermal spray and welding wire compositions and the use of such compositions in applications requiring high surface roughness while maintaining high hardness, high stress abrasion resistance, and increasing cladding-to-substrate bond strength

Cladding relates generally to techniques or methods of applying a hard, wear resistant alloy to the surface of a substrate, such as a softer metal, to reduce wear caused by abrasion, erosion, corrosion, and heat, among other operational or environmental conditions. In some applications, especially anti-skid and gripping applications, there is a need for a cladding deposit with high surface roughness while maintaining the alloys high hardness and abrasion resistance. In applications where the cladding is in a tensional force, there is a need for increasing cladding-to-substrate bond strength.

A variety of methods are available to apply high hardness, high stress abrasion alloys with high cladding-to-substrate bond strength, among which includes welding, where a welding wire is deposited over the substrate surface to produce a cladding deposit that is metallurgically fusion bonded to the substrate. A method to apply high hardness, high stress abrasion alloys with low cladding-to-substrate bond strength is twin-wire arc spray (TWAS), where a welding wire is sprayed over the substrate to produce a mechanically bonded metal coating. The welding wire may include a solid wire, metal-cored wire or a flux-cored wire, wherein the metal-cored wire generally comprises a metal sheath filled with a powdered metal alloy and the flux-cored wire generally comprises a mixture of powdered metal and fluxing ingredients. Accordingly, flux-cored and metal-cored wires offer additional versatility due to the wide variety of alloys that can be included within the powdered metal core in addition to the alloy content provided by the sheath. Cladding uses a similar welding process and generally applies a relatively thick layer of filler metal to a substrate to provide a high hardness, high stress abrasion resistant surface.

Conventional cladding alloys that are welded are prized for their high surface hardness, high stress abrasion resistance, and high cladding-to-substrate bond strength of up to 60,000 psi. However, what conventional cladding alloys that are welded lack is high surface roughness that is naturally formed. Currently, in order to achieve a naturally formed high surface roughness, cladding is sprayed using a twin-wire arc spray (TWAS) process which results in significantly decreased cladding-to-substrate bond strength of up to only 7,000 psi.

Improved compositions in the areas of cladding are continually desired in the field of welding, especially in environments that require high hardness, high stress abrasion resistance, and high cladding-to-substrate bond strength.

### SUMMARY

In general, a welding wire yielding a high surface roughness deposit is provided for use in cladding applications to increase surface frictional forces to reduce slip and increase grip while maintaining high hardness and abrasion resistance. The welding wire composition according to the present disclosure is particularly suitable for metal-to-metal and metal-to-earth applications where anti-slip and pro-grip are desired. Preliminary testing has shown an increase in surface roughness of about 50% in thermal spray applications and an increase in surface roughness of about 100% in welding applications.

In one form, a welding wire is manufactured by forming a mild steel sheath into a tube and filling the tube with various alloy powders. The filled sheath is then formed to size by rolling and/or drawing. After welding, the sheath and alloy powder produce a semi-austenitic weld deposit matrix with finely dispersed carbides such as Boron (B), Chromium (Cr), Molybdenum (Mo), Niobium (Nb), Vanadium (V), and/or Tungsten (W). Advantageously, the percent weight of Boron (B), Chromium (Cr), Molybdenum (Mo), Niobium (Nb), Vanadium (V), and/or Tungsten (W) in the compositions of the present disclosure have been balanced, thus allowing Vanadium (V), one of the principle alloying elements, to form vanadium carbides readily in the iron matrix offering a weld deposit with high hardness and abrasion resistance. Due to Vanadium's effect on the cooling rate of the weld deposits, the Examples described below suggest that the Vanadium (V) causes a “pinch-point” effect by breaking the surface tension of the weld deposit, thus causing the high surface roughness.

In one form of the present disclosure, a weld deposit composition for a welding application is provided that comprises, by percent mass, between approximately 0.0% and approximately 2.0% Boron (B), between approximately 1.0% and approximately 7.0% Carbon (C), between approximately 0.01% and approximately 6.0% Chromium (Cr), between approximately 0.01% and approximately 12.0% Manganese (Mn), between approximately 0.01% and approximately 4.0% Molybdenum (Mo), between approximately 0.0 and approximately 3.0% Niobium (Nb), between approximately 0.01 and approximately 2.5% Silicon (Si), between approximately 3.5% and approximately 10.0% Vanadium (V), between approximately 0.01% and approximately 4.0% Tungsten (W), and a balance comprising of Iron (Fe). In additional forms, the Boron (B) composes approximately 0.2%, the Carbon (C) composes approximately 4.5%, the Chromium (Cr) composes approximately 4.0%, the Manganese (Mn) composes approximately 3.0%, the Molybdenum (Mo) composes approximately 2.5%, the Niobium (Nb) composes approximately 0.3%, the Silicon (Si) composes approximately 2.0%, the Vanadium (V) composes approximately 4.0%, and the Tungsten (W) composes approximately 2.5%.

In yet other forms of the present disclosure, a welding wire, or a flux-cored or metal-cored welding wire capable of producing a weld deposit having the above-mentioned elements and a welded structure having a weld deposit with the above elements is provided by the teachings of the present disclosure. The welded structure may be, by way of example, anti-slip and/or pro-grip for metal-to-metal or metal-to-earth applications requiring high hardness, high stress abrasion resistance, and high cladding-to-substrate bond strength.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements.

FIG. 1 depicts a schematic cross-sectional view of a cladding alloy deposit using a twin wire arc spray (TWAS) process;

FIG. 2 depicts a schematic cross-sectional view of another cladding alloy deposit using the TWAS process;

FIG. 3 depicts a schematic cross-sectional view of the cladding alloy deposit of FIG. 1 using an open arc weld (OAW) process;

FIG. 4 depicts a schematic cross-sectional view of another cladding alloy deposit using the OAW process; and

FIG. 5 depicts a schematic cross-sectional view of another cladding alloy deposit using the OAW process.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Weld alloy compositions for use in cladding applications that increase surface roughness are provided by balancing percent weights of carbides such as Boron (B), Chromium (Cr), Molybdenum (Mo), Niobium (Nb), Vanadium (V), and Tungsten (W). This balancing allows Vanadium (V), one of the principle alloying elements, to form vanadium carbides readily in the iron matrix offering a weld deposit with high hardness and abrasion resistance. Due to Vanadium's effect on the cooling rate of the weld deposits, the Examples described below suggest that the Vanadium (V) causes a “pinch-point” effect by breaking the surface tension of the weld deposit, thus causing the high surface roughness. In one form, a weld deposit is produced from a metal-cored wire, however, it should be understood that other types of welding consumables such as a solid wire, flux-cored wire, or coated shielded metal arc electrodes may also be employed while remaining within the scope of the present disclosure. The weld deposit characteristics include a complex carbide composition, a semi-austenitic weld deposit matrix with finely dispersed carbides with Vanadium (V) being the principle alloying element. Additional alloying elements are provided for various properties of the weld deposit and are described in greater detail below.

The specific alloy elements and their amounts that are present in the weld deposits according to the teachings of the present disclosure are now described in greater detail.

Boron (B) is an element that provides interstitial hardening in the matrix, strengthens the grain boundaries by accommodating mismatches due to incident lattice angles of neighboring grains with respect to the common grain boundary, and by itself or in combination with Carbon, form nucleation sites as intermetallics. When included, the preferred amount of Boron for the welding and thermal spray application is between approximately 0.0 and approximately 2.0 percent, with a target value of approximately 0.2%. In some examples, Boron can be excluded from the cladding material.

Carbon (C) is an element that improves hardness and abrasion resistance. The amount of Carbon for welding and thermal spray is between approximately 1.0 and 7.0 percent with a target value of approximately 4.5 percent. Alternatively, in some examples Carbon concentration is between approximately 1.5 and 6.0 percent with a target value of approximately 4.5 percent.

Cobalt (Co) is an element that improves strength at high temperatures. In the present alloy, Cobalt is generally only present as an impurity. However, in some examples, the amount of Cobalt for welding and thermal spray is between approximately 0.0 and 11.0 percent. Alternatively, the amount of Cobalt for welding and thermal spray is between approximately 0.05 and 3.0 percent. In still other examples, Cobalt is included with a target value of approximately 0.2%.

Chromium (Cr) is an element that provides abrasion resistance as chromium carbide, corrosion resistance, carbide/boride formation, and improved high temperature creep strength. The preferred amount of Chromium for welding and thermal spray application is between approximately 0.01 to 6.0 percent with a target value of approximately 4.0 percent. Alternatively, in some examples Chromium concentration is between approximately 0.01 and 6.5 percent. In still other examples, Chromium concentration is between 4.0 and 8.0 percent. In yet other examples, Chromium is present with a target value of approximately 4.3 percent.

Manganese (Mn) is an element that improves hardness, toughness and acts as a deoxidizer, in which the deoxidizer also acts as a grain refiner when fine oxides are not floated out of the metal. Manganese (Mn) also stabilizes austenite thus leading to better ductility of overlay. The amount of Manganese for welding and thermal spray application is between approximately 0.01 and 12.0 percent with a target value of approximately 3.0%. Alternatively, in some examples Manganese concentration is between approximately 0.01 and 3.5 percent. In still other examples, Manganese is present with a target value of approximately 0.3 percent.

Molybdenum (Mo) is an element that provides improved tensile strength of the weld deposit as carbide, boride, or a solid-solution strengthener. Molybdenum (Mo) also provides resistance to pitting corrosion. The preferred amount of Molybdenum for welding and thermal spray application is between approximately 0.01 and 4.0 percent with a target value of approximately 2.5%. Alternatively, in some examples Molybdenum concentration is less than or equal to 8.0 percent. In still other examples, Molybdenum is present in concentrations between approximately 0.01 and 5.5 percent. In yet other examples, Molybdenum is present with a target value of approximately 4.4 percent.

Niobium (Nb) is an element that acts as a grain refiner, deoxidizer, and primary carbide/boride former. The amount of Niobium for welding and thermal spray application is between approximately 0.0 and 3.0 percent, with a target value of approximately 0.3%. Alternatively, in some examples Niobium concentration is between 0.0 and 5.0 percent. In still other examples, Niobium has a target value of approximately 0.2 percent. In yet other examples, Niobium can be excluded from the cladding material entirely.

Like Niobium, Titanium (Ti) acts as a grain refiner, deoxidizer, and primary carbide/boride former. In the present example, Titanium is not intentionally added to the alloy and is therefore only present as an impurity. However, in some alternative examples Titanium is concentration is between approximately 0.05 and 5.0 percent. In still other examples, Titanium concentration has a target value of approximately 0.3 percent.

Nickel (Ni) is an element that provides improved ductility, which improves resistance to impacts at lower temperatures, and provokes the formation of austenite thus leading to less relief check cracking. In the present example, Nickel is omitted entirely and is therefore only present as an impurity. Alternatively, in some examples, the amount of Nickel for welding and thermal spray application is between approximately 0.0 and 4.0 percent. In still other examples, the amount of Nickel for welding and thermal spray application is between approximately 0.01 and 2.0 percent. In yet other examples, the Nickel concentration has a value of approximately 0.3%

Silicon (Si) is an element that acts as a deoxidizer to improve corrosion resistance and which also acts as a grain refiner when fine oxides are not floated out of the metal. Silicon is also added to the weld metal to improve fluidity. The preferred amount of Silicon for welding and thermal spray application is between approximately 0.01 and 2.5 percent with a target value of approximately 2.0%. Alternatively, in some examples Silicon concentration is between 0.0 and 4.0 percent. In still other examples, Silicon is present with a target value of approximately 0.3 percent.

Vanadium (V) is an element that, due to its high affinity for carbon, is more likely to form carbides in the iron matrix. These carbides improve the strength, hardness, and impact toughness of the alloy. The Examples described below suggest that this element is responsible for increasing the surface roughness of the deposit by affecting the cooling rate of the deposit, as set forth in greater detail below. The preferred amount of Vanadium for welding and thermal spray application is between approximately 3.5 and 10.0 percent with a target value of approximately 4.0 percent. Alternatively, in some examples Vanadium concentration is between approximately 3.5 and 25.0 percent. In still other examples, Vanadium is present in concentrations between approximately 3.5 and 16.5 percent. In yet other examples, Vanadium concentration has a target value of approximately 4.1 percent.

Tungsten (W) is an alloying element that, due to the formation of stable carbides, increases hardness especially at elevated temperatures. The preferred amount of Tungsten for welding and thermal spray application is between approximately 0.01 and 4.0 percent with a target value of 2.5 percent. Alternatively, in some examples Tungsten concentration is between approximately 0.0 and 8.0 percent. In still other examples Tungsten is present in concentrations between approximately 0.01 and 7.0 percent. In yet other examples, Tungsten has a target value of approximately 5.9 percent.

Increasing the amount of Vanadium in steel can have a profound effect on the cooling rate of iron-based alloys. As the alloy cools after being welded on a softer metal surface, the surface tension on the surface of the weld deposit is broken upon cooling causing a “pinch-point” effect, thus naturally producing a weld surface with high surface roughness while maintaining high hardness and high stress abrasion resistance. In exemplary testing, when removing vanadium from the alloy of present disclosure the “pinch-point” effect is non-existent as shown and described below in Examples 1-3.

It should be understood that in other examples, variations in the concentrations of elements and the particular elements selected may be made. Of course, where such variations are made, it should be understood that such variations may have a desirable or undesirable effect on the alloy microstructure and/or mechanical properties in accordance with the properties described above for each given alloying addition.

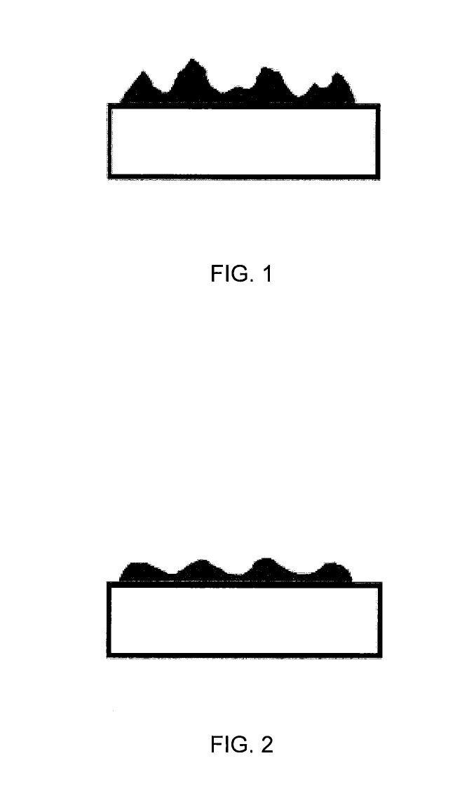

The compositions of the weld deposits according to the teachings of the present disclosure are formulated to determine the effect of surface roughness compared to conventional cladding alloys. In exemplary testing, the compositions have shown significant increases in surface roughness when compared to the typical thermal spray and weld deposit compositions as described below in Examples 1, 2, and 3, and shown in FIGS. 1-5. While comparing the alloy of present disclosure to conventional alloys, the alloy of disclosure presents a higher surface roughness while maintaining similar hardness, high stress abrasion resistance, and bond strength to substrate

### EXAMPLE 1

Referring to Tables 1, 2 and 3 below for Examples 1, 2 and 3, respectively, weld deposit compositions (including both target percentages and ranges of percent elements by weight) according to the present disclosure are listed for both thermal spray and welding applications, along with typical thermal spray and welding wire compositions for purposes of comparison.

In Table 1 shown below, samples were prepared using TWAS to clad the surface of a predetermined substrate. In Experiment A, cladding material having one of the compositions of the present disclosure was deposited onto the predetermined substrate. In Experiment B, a comparative example was prepared by depositing a cladding material having a typical composition used for anti-slip properties in TWAS processes onto the predetermined substrate. In both instances, TWAS was used to deposit the cladding material.

TABLE 1

| | | | Experiment B |
|---|---|---|---|
| | Alloy of Present | Experiment A | Typical Thermal |
| | Disclosure Range | Alloy of Present | Spray Cladding |
| | Thermal Spray | Disclosure Target | Alloy |
| Alloy Type | (TWAS) or Open | Thermal | Thermal |
| Application | Arc Weld | Spray | Spray |
| Process | (OAW) | (TWAS) | (TWAS) |
| Al | — | — | 5 |
| B | 0.0-2.0 | 0.2 | — |
| C | 1.0-7.0 | 4.5 | 2 |
| Cr | 0.01-6.0 | 4.0 | — |
| Fe | Balance | Balance | Balance |
| Mn | 0.01-12.0 | 3.0 | 1 |
| Mo | 0.01-4.0 | 2.5 | — |
| Nb | 0.0-3.0 | 0.3 | — |
| Si | 0.01-2.5 | 2.0 | 0.3 |
| V | 3.5-10.0 | 4.0 | — |
| W | 0.01-4.0 | 2.5 | — |
| Hardness | | High | High |
| | | (61 HRC) | (58 HRC) |
| High Stress | | High | High |
| Abrasion | | (0.065 g | (0.068 g |
| Resistance | | ASTM G65-D) | ASTM G65-D) |
| Bond | | Low | Low |
| Strength | | (~7,000 psi) | (~7,000 psi) |
| Surface | | High | Medium |
| Roughness | | | |

In FIGS. 1 and 2 the resulting Experiments A and B of Table 1 are shown schematically in cross-section, respectively. In particular, FIG. 2 shows the results of the cladding of the comparative example having typical anti-slip composition. Similarly, FIG. 1 shows the results of the cladding having a composition of the alloy of the present disclosure. As can be seen by comparing FIGS. 1 and 2, the cladding composition of the present disclosure results in increased surface roughness in comparison to the surface roughness found in the comparative example. However, both of the resulting claddings exhibit limited substrate penetration, thereby resulting in relatively low bond strength. The particular surface roughness of the present example has been characterized as “high,” while the surface roughness of the comparative example has been characterized as “medium.”

### EXAMPLE 2

In Table 2 shown below, three samples were prepared with each sample being labeled as Experiment C, D and E, respectively. In Experiment C, a cladding was prepared using an open arc weld process (OAW) and a cladding composition in accordance with an alloy of the present disclosure. Experiment D was prepared in substantially the same way as with Experiment C (e.g., using an OAW process), except Vanadium (V) was excluded from the cladding composition. Experiment E was also prepared using an OAW process. However, unlike Experiments C and D, Experiment E was prepared using a cladding material with a composition consistent with those typically used in OAW cladding processes.

TABLE 2

| | | | Experiment D | Experiment E |
|---|---|---|---|---|
| | Alloy of Present | Experiment C | Alloy of Present | Typical Open |
| | Disclosure Range | Alloy of Present | Disclosure Without | Arc Weld |
| | Thermal Spray | Disclosure | Vanadium | Cladding Alloy |
| Alloy Type | (TWAS) or Open | Open Arc | Open Arc | Open Arc |
| Application | Arc Weld | Weld | Weld | Weld |
| Process | (OAW) | (OAW) | (OAW) | (OAW) |
| Al | — | — | — | — |
| B | 0.0-2.0 | 0.2 | 0.2 | — |
| C | 1.0-7.0 | 4.5 | 4.5 | 5 |
| Cr | 0.01-6.0 | 4.0 | 4.0 | 23 |
| Fe | Balance | Balance | Balance | Balance |
| Mn | 0.01-12.0 | 3.0 | 3.0 | 2 |
| Mo | 0.01-4.0 | 2.5 | 2.5 | — |
| Nb | 0.0-3.0 | 0.3 | 0.3 | — |
| Si | 0.01-2.5 | 2.0 | 2.0 | 1 |
| V | 3.5-10.0 | 4.0 | — | — |
| W | 0.01-4.0 | 2.5 | 2.5 | — |
| Hardness | | High | Medium | High |
| | | (63 HRC) | | (58 HRC) |
| High Stress | | High | Low | High |
| Abrasion Resistance | | | | (0.16 g |
| | | | | ASTM G65-A) |
| Bond Strength | | High | High | High |
| | | (~60,000 psi) | (~60,000 psi) | (~60,000 psi) |
| Surface Roughness | | Very High | Very Low | Very Low |

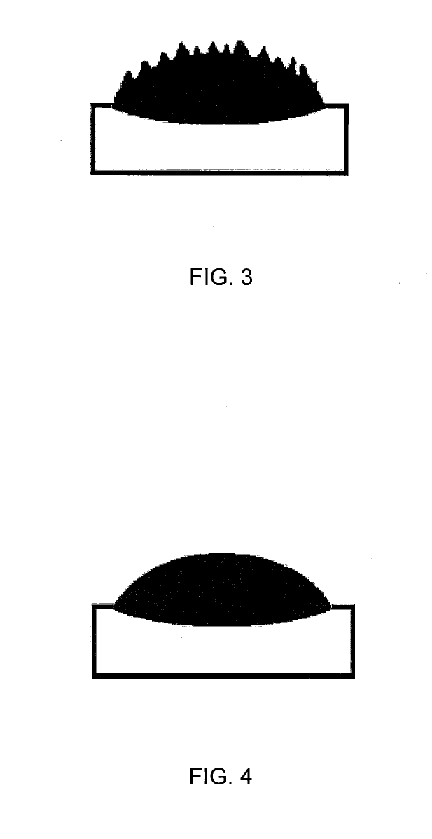

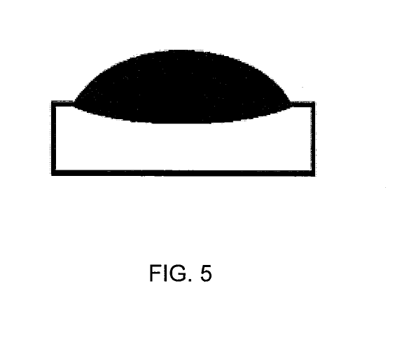

FIGS. 3, 4, and 5 show the results of Experiments C, D and E, respectively. These results a presented as schematic cross-sectional views. As can be seen, the cladding of FIG. 3 includes some penetration into the substrate as well as a surface roughness that can be characterized as very high. The increased substrate penetration shown in FIG. 3 resulted in increased bond strength (characterized here as “high”) relative to claddings described herein with limited substrate penetration. While FIGS. 4 and 5 also show some substrate penetration, notably surface roughness can only be characterized as very low. Accordingly, it should be understood that the presence of Vanadium (V) can lead to increased surface roughness. Therefore, when comparing the results of Experiments C, D, and E, it is apparent that the alloy of the present disclosure presents a higher surface roughness while maintaining similar hardness, high stress abrasion resistance, and bond strength to the substrate.

### EXAMPLE 3

In Table 3 below, Experiments B and C described above in connection with Examples 1 and 2, respectively, are compared. As similarly described above, Experiment B provides a comparative example of a cladding material having a typical anti-slip composition used in TWAS processes onto the predetermined substrate using the TWAS process. By contrast, Experiment C was prepared using the OAW process with a cladding composition of the alloy of the present disclosure.

TABLE 3

| | Alloy of Present | Experiment B | Experiment C |
|---|---|---|---|
| | Disclosure Range | Typical Anti-Slip | Alloy of |
| | Thermal Spray | Cladding Alloy | Present Disclosure |
| Alloy Type | (TWAS) or Open | Thermal | Open Arc |
| Application | Arc Weld | Spray | Weld |
| Process | (OAW) | (TWAS) | (OAW) |
| Al | — | 5 | — |
| B | 0.0-2.0 | — | 0.2 |
| C | 1.0-7.0 | 2 | 4.5 |
| Cr | 0.01-6.0 | — | 4.0 |
| Fe | Balance | Balance | Balance |
| Mn | 0.01-12.0 | 1 | 3.0 |
| Mo | 0.01-4.0 | — | 2.5 |
| Nb | 0.0-3.0 | — | 0.3 |
| Si | 0.01-2.5 | 0.3 | 2.0 |
| V | 3.5-10.0 | — | 4.0 |
| W | 0.01-4.0 | — | 2.5 |
| Hardness | | High | High |
| | | (58 HRC) | (63 HRC) |
| High Stress | | High | High |
| Abrasion | | (0.068 g | |
| Resistance | | ASTM G65-D) | |
| Bond | | Low | High |
| Strength | | (~7,000 psi) | (~60,000 psi) |
| Surface | | Medium | Very High |
| Roughness | | | |

The results of Experiments B and C can be seen by comparing FIGS. 2 and 3, respectively. As can be seen, the resulting cladding of Experiment B shown in FIG. 2 results in a cladding with a medium surface roughness with limited penetration into the substrate and relatively low bond strength as a consequence of such limited penetration. In FIG. 3, Experiment C results in a cladding with a very high surface roughness and some penetration into the substrate. Existing filler metals that are typical anti-skid cladding alloys must be applied via TWAS processes. This results in a cladding with only medium surface roughness characteristics and only low bond strength. When such typical anti-skid cladding alloys are applied using OAW processes, surface roughness is almost entirely eliminated. Accordingly, it should be understood that when an alloy of the present disclosure is applied with the OAW process, a resulting cladding with high bond strength and very high surface roughness can be achieved. Additionally, cladding hardness and high stress abrasion resistance remains within suitable ranges.

While both methods of applying the alloy of present disclosure exhibit high surface roughness while maintaining high hardness and high stress abrasion resistance, when comparing the two methods, exemplary testing shows that the key difference in the processes is the increased bond strength of the welded deposit as opposed to the thermal spray deposit as shown by comparing FIGS. 1 and 3. This is due to the type of bonding to the substrate. Thermal spray deposits are bonded to a substrate using a mechanical bond, while welded deposits exhibit a much stronger metallurgical fusion bond.

The description of the disclosure is merely exemplary in nature and, thus, variations that do not depart from the gist of the disclosure are intended to be within the scope of the disclosure. For example, the weld deposit according to the teachings of the present disclosure may be produced from welding wire types other than flux-cored/metal-cored wires, such as solid wires, shielded metal arc wires, stick electrodes, or PTA powders, while remaining within the scope of the present disclosure. Additionally, while TWAS and OAW processes are described herein, it should be understood that the teachings herein may be readily applied to other processes such as shielded metal arc welding, submerged arc welding, gas tungsten arc welding, gas metal arc welding, and/or etc. Such variations are not to be regarded as a departure from the spirit and scope of the disclosure.

What is claimed is:

1. A weld deposit composition for a welding and/or thermal spray application comprising, by percent mass:
between approximately 0.0% and approximately 2.0% Boron;
between approximately 1.0% and approximately 7.0% Carbon;
between approximately 0.01% and approximately 6.5% Chromium;
between approximately 0.01% and approximately 12.0% Manganese;
between approximately 0.01% and approximately 5.5% Molybdenum;
between approximately 0.0% and approximately 5.0% Niobium;
between approximately 0.0% and approximately 2.5% Silicon;
between approximately 3.5% and approximately 16.5% Vanadium; and
between approximately 0.01% and approximately 4.0% Tungsten.

2. The weld deposit composition according to claim 1, wherein the Chromium comprises between approximately 0.01% and 6.0%.

3. The weld deposit composition according to claim 2, wherein the Chromium comprises approximately 4.0%.

4. The weld deposit composition according to claim 1, wherein the Manganese comprises between approximately 0.01% and 3.5%.

5. The weld deposit composition according to claim 4, wherein the Manganese comprises approximately 3.0%.

6. The weld deposit composition according to claim 1, wherein the Molybdenum comprises between approximately 0.01% and 4.0%.

7. The weld deposit composition according to claim 6, wherein the Molybdenum comprises approximately 2.5%.

8. The weld deposit composition according to claim 1, wherein the Niobium comprises between approximately 0.0% and 3.0%.

9. The weld deposit composition according to claim 8, wherein the Niobium comprises approximately 0.3%.

10. The weld deposit composition according to claim 1, wherein the Silicon comprises between approximately 0.01% and 2.5%.

11. The weld deposit composition according to claim 10, wherein the Silicon comprises approximately 2.0%.

12. The weld deposit composition according to claim 1, wherein the Vanadium comprises between approximately 3.5% and 10.0%.

13. The weld deposit composition according to claim 12, wherein the Vanadium comprises approximately 4.0%.

14. The weld deposit composition according to claim 1, wherein the Tungsten comprises between approximately 0.01% and 4.0%.

15. The weld deposit composition according to claim 14, wherein the Tungsten comprises approximately 2.5%.

16. The weld deposit composition according to claim 1, wherein the weld deposit composition comprises a welding wire.

17. The weld deposit composition according to claim 1, wherein the weld deposit composition forms a welded structure.

18. A cladding composition comprising, by percent mass:
approximately 1.0% to 7.0% carbon;
approximately 0.01% to 12.0% manganese;
approximately 0.01% to 2.5% silicon;
approximately 0.01% to 6.0% chromium;
approximately 0.01% to 4.0% molybdenum;
approximately 3.5% to 10.0% vanadium;
approximately 0.01% to 4.0% tungsten; and
the balance comprising iron and unavoidable impurities.

19. The cladding composition of claim 18, further comprising at least one member of a group consisting of: approximately 0.0%-2.0% boron, and approximately 0.0%-3.0% niobium.

20. A weld deposit composition for a welding and/or thermal spray application comprising, by percent mass:
approximately 1.0% to 7.0% carbon;
approximately 0.01% to 12.0% manganese;
approximately 0.01% to 2.5% silicon;
approximately 0.01% to 6.0% chromium;
approximately 0.01% to 4.0% molybdenum;
approximately 3.5% to 16.5% vanadium;
approximately 0.01% to 4.0% tungsten; and
the balance comprising iron and unavoidable impurities.
